(19) United States
(12) Patent Application Publication
(10) Pub. No.: US 2018/0040035 A1
(43) Pub. Date: Feb. 8, 2018

(54) Automated Audience Selection Using Labeled Content Campaign Characteristics

(71) Applicant: Facebook, Inc., Menlo Park, CA (US)

(72) Inventor: Peng Qi, Redwood City, CA (US)

(21) Appl. No.: 15/226,840

(22) Filed: Aug. 2, 2016

(51) Int. Cl. G06Q 30/02

(52) U.S. Cl. CPC G06Q 30/0276; G06Q 30/0255; G06Q 30/0275

(57) ABSTRACT

An online system generates target audiences for a new content campaign based on target audiences for similar content campaigns. A content provider submits to the online system a request to create a new content campaign, and the online system compares keywords associated with the new campaign with keywords associated with existing campaigns to calculate and adjust similarity scores. The online system retrieves target audiences for campaigns that have a similarity score that equals or exceeds a threshold and uses the retrieved target audiences to create a target audience for the new campaign.

### BACKGROUND

The disclosure relates generally to online systems, and in particular to using information about one content provider to identify and select a target audience of users of an online system for another content provider.

An online system, such as a social networking system, allows its users to connect to and communicate with other online system users. Users may create profiles on an online system that are tied to their identities and include information about the users, such as interests and demographic information. The users may be individuals or entities such as corporations or charities. Because of the increasing popularity of online systems and increasing amount of user-specific information that they maintain, an online system provides an ideal forum for content providers to increase awareness about products or services by presenting content items to online system users as stories in social networking newsfeeds or via other presentation mechanisms.

Users are typically presented with a large number of content items and interact with only a few of the content items received. Users often ignore content items sent by the online system, and as a result, the online system wastes resources by sending the ignored content items. Content providers would prefer to send content to users that are likely to interact with the content.

Generally, content providers have various websites accessible to online system users in various locations on which content is provided to users. However, content providers generally do not have access to information that an online system associates with users and uses to provide more interesting content that users are less likely to ignore. This limitation of the information available to content providers makes it difficult for them to effectively identify content to the online system for presentation to various users. Similarly, new content providers or content providers beginning a new content campaign may have difficulty identifying a target audience for their product, service, or campaign.

### SUMMARY

To enable content providers to target content for presentation to a group of users of an online system, the online system compares keywords associated with a new content campaign with keywords associated with existing content campaigns. A target audience for the new campaign is generated from target audiences for existing campaigns with similar keywords. In this way, the online system leverages for a content provider's new campaign the wealth of information it has about similar content campaigns to find the best audience for the new campaign.

The online system stores user profiles describing users to whom content may be provided, including likes and dislikes of the user, interactions with other users in the online system, demographic information, etc. The online system receives from the content provider keywords associated with the content provider, the content, and/or the content campaign. Additionally or alternatively, the online system extracts keywords from other content associated with the content provider. The online system then determines similar content campaigns by comparing the received or extracted keywords with keywords associated with other campaigns. For each of the similar campaigns, the system identifies an audience of users of the online system to whom the similar campaigns target content items, and generates a target audience for the content provider based on the target audiences of the similar campaigns.

For example, assume that a provider of men's athletic shoes has associated with its content campaign keywords such as “sneaker,” “running,” “basketball,” and so on. In conjunction with its campaign, the content provider specifies that the users targeted for receiving the content items should have a gender listed as male and should have an interest in sports, as determined by the online system. Similarly, assume that a provider of children's apparel has associated with one of its content campaign keywords such as “youth,” “kids,” “t-shirts,” and so on. In conjunction with its campaign, the provider specifies that the users targeted for receiving the content items should have an age in the range of 20-40 years and should have at least one child. If a provider of athletic apparel wishes to create advertising content campaign for a new line of youth basketball shoes, it will input to the online system keywords such as “sneaker,” “basketball,” “youth,” “children,” and so on. The system will compare these keywords with the keywords used by the provider of men's athletic shoes and the provider of children's apparel, and upon determining that the campaigns are associated with similar keywords (e.g., based on some threshold number of keyword matches across campaigns), will use the target audiences specified above to recommend a target audience to the athletic apparel provider.

The features and advantages described in this summary and the following description are not all-inclusive. Many additional features and advantages will be apparent to one of ordinary skill in the art in view of the drawings, specification, and claims herein.

### BRIEF DESCRIPTION OF THE DRAWINGS

FIG. 1 a block diagram of a system environment in which an online system operates, in accordance with an embodiment

FIG. 2 is a block diagram of an online system, in accordance with an embodiment.

FIG. 3 is a conceptual illustration of a method for creating target audiences using labeled content campaign characteristics, in accordance with an embodiment.

FIG. 4 is a flow diagram illustrating a method for creating target audiences using labeled content campaign characteristics, in accordance with an embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

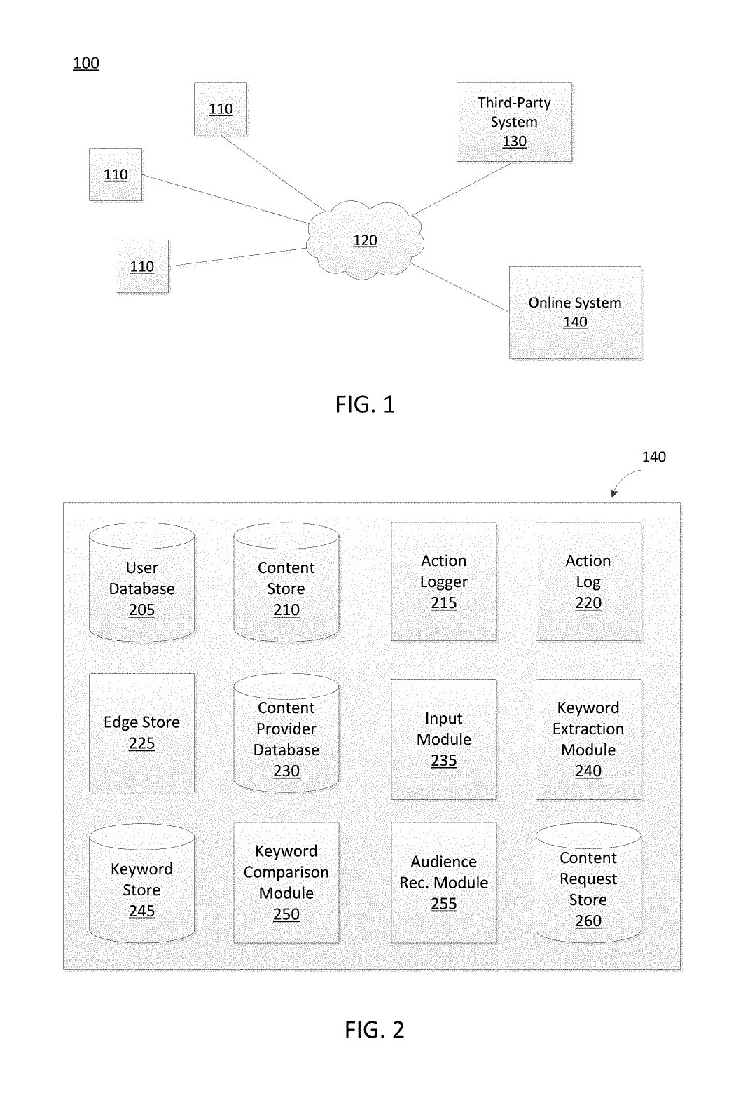

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. In one embodiment, the online system 140 is a social networking system.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system through an application programming interface (API) running on a native operating system of the client device 110, such as IOS® or ANDROID™.

The network 120 may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communications links of the network 120 may be encrypted using any suitable technique or techniques.

One or more third party systems 130 are coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via the client device 110. A third party website 130 communicates information to the online system 140, such as advertisements, content, or information about an application provided by the third party system 130.

### Online System

FIG. 2 is a block diagram of an architecture of the online system 140. The online system 140 shown in FIG. 2 includes a user database 205, a content store 210, an action logger 215, an action log 220, an edge store 225, a content provider database 230, an input module 235, a keyword extraction module 240, a keyword store 245, a keyword comparison module 250, an audience recommendation module 255, and a content request store 260. In other embodiments, the online system 140 may include additional, fewer, or different components for various applications. Conventional components such as network interfaces, security functions, load balancers, failover servers, management and network operations consoles, and the like are not shown so as not to obscure the details of the system architecture.

Each user of the online system 140 is associated with a user profile, which is stored in the user database 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location, and the like. A user profile may also store other information provided by the user, for example, images or videos. In certain embodiments, images of users may be tagged with information identifying the online system users displayed in an image. In another embodiment, a user profile in the user database 205 maintains references to actions performed by the corresponding user on content items in the content store 210 and stores those actions in the action log 220.

While user profiles in the user database 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups, or applications. In some embodiments, objects are received from third-party applications or third-party applications separate from the online system 140. In one embodiment, objects in the content store 210 represent single pieces of content, or content “items.” Hence, users of the online system 140 are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action logger 215 is used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action logger 215 may record a user's interactions with advertisements of the online system 140 as well as with other applications operating on the online system 140. In some embodiments, data from the action log 220 is used to infer interests or preferences of a user, augmenting the interests included in the user's profile and allowing a more complete understanding of user preferences.

In one embodiment, the action log 220 also stores user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action logger 215 may record information about actions users perform on a third party system 130, including webpage viewing histories, content items that were engaged, purchases made, and other patterns from shopping and buying.

In one embodiment, the edge store 225 stores information describing connections between users and other objects of the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140. Users and objects can be represented as nodes connected by these edges in a social graph. Once a user has interacted with an object, the edge in the graph links that user with that object, and this link can be used in the future to serve other content to the user related to that object to which the user has a connection.

In one embodiment, an edge includes various features each representing characteristics of interactions between users, interactions between users and objects, or interactions between objects. For example, features included in an edge describe the rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. In one embodiment, affinity scores, or “affinities,” are computed by the online system 140 over time to approximate a user's interest in an object or another user in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user database 205, or the user database 205 may access the edge store 225 to determine connections between users.

Each content provider that provides content on the online system 140 is associated with a content provider profile, which is stored in the content provider database 230. A content provider profile includes declarative information about the provider that was explicitly shared by the provider and may also include information inferred by the online system 140. In one embodiment, a content provider profile includes multiple data fields, each describing one or more attributes of the corresponding provider. Examples of information stored in a content provider profile include products or services that the content provider provides or intends to provide on the online system 140, content campaigns, and keywords and target audiences associated with the campaigns.

The input module 235 receives information from a content provider regarding the content campaign for which the online system 140 will generate the target audience. In one embodiment, the information includes the content itself as well as keyword labels describing the content, the campaign, and the content provider. For example, a retailer of athletic apparel that is creating a new content campaign for youth basketball shoes might input to the input module 235 keywords such as “sneaker,” “basketball,” “youth,” “children,” and so on.

The keyword extraction module 240 extracts keywords regarding the content provider, the content, and/or the content campaign from other content associated with the content provider and stores the extracted keywords in the keyword store 245. For example, the keyword extraction module 240 might extract keywords from an advertisement provided to the online system by the content provider. It might extract keywords from the content provider's profile about the content provider in general or about the particular campaign that the content provider is running. It might also extract keywords from the brand page associated with the content provider's profile (e.g., a brand page on a social networking system for the brand associated with the content provider) or from a third-party website (e.g., the content provider's own website external to or in a domain separate from that of the online system), such as a page linked to when a user of the online system 140 clicks through the content (e.g., a product catalog), to an entity associated with the content (i.e., a page, if different from the click-through page), or to the content of a page.

The keyword extraction module 240 uses statistical algorithms and natural language processing technology to analyze the information associated with the content provider and identify relevant keywords. In some embodiments, the keyword extraction module 240 uses a Rapid Automatic Keyword Extraction (RANK) algorithm, a Term Frequency-Inverse Document Frequency (TF-IDF) algorithm, or a TextRank algorithm to perform the keyword extraction. Other typical supervised machine learning algorithms can also be used. For example, the text of a sponsored content item can be sent to a human to label with keywords. This data could be used to train a neural network classifier, which could label other ads such that even if some specific keywords do not appear in the text, the content item can still be labeled with those keywords. Alternatively, keywords can be extracted from images and/or videos in the sponsored content items using machine learning algorithms.

The keyword extraction module 240 stores the extracted keywords in the keyword store 245 for later comparison by the keyword comparison module 250. In some embodiments, the keyword extraction module 240 prioritizes the extracted keywords. For example, the keyword extraction module 240 might rank keywords based on the number of times the keyword appears in the content associated with the content provider. It might rank the keywords based on the placement of the keywords on the page. It might also rank the keywords based on the size of the font or the conspicuousness of the keyword or its placement (e.g., larger text, highlighted text, different colored text). One of ordinary skill in the art will appreciate that other methods of ranking the keywords are possible.

The keyword extraction module 240 extracts keywords for both new content campaigns and existing campaigns on the online system 140. Extracting keywords from existing campaigns is necessary in order for the keyword comparison module 250 to perform a comparison between keywords associated with a new advertising campaign with keywords associated with existing campaigns.

The keyword comparison module 250 compares keywords associated with a new content campaign with keywords associated with other content campaigns to identify existing campaigns that are similar to the new campaign. In one embodiment, the keyword comparison module 250 determines similarity by looking for matching terms between the keywords associated with the new content campaign and the keywords associated with the existing campaigns. From the matching terms, the keyword comparison module 250 computes a similarity score for each existing campaign. In one embodiment, the similarity score is determined by the number of keywords associated with the new content campaign that are also associated with the existing campaign. If the keyword comparison module 250 determines that the similarity score for a particular campaign equals or exceeds a threshold value, the keyword comparison module 250 characterizes the campaign as similar to the new campaign. The similarity score may equal or exceed a threshold value if a threshold number of keywords match across the two campaigns. Similarly, where the keywords are ranked or assigned a weight representing the importance of the keyword, the similarity score may equal or exceed a threshold value when a threshold number of keywords at the top of the ranking (e.g., at least 3 in the top 15 highest ranked keywords) or the weighting (e.g., at least 2 of the top 10 highest weighted keywords, or requiring that at least the top two keywords in the weighting are included) are matched across the two campaigns.

Additionally or alternatively, the keyword comparison module 250 determines similarity by comparing the content of the new content campaign with the content of the existing campaigns. In one embodiment, the keyword comparison module 250 compares the products or services associated with the campaigns as well as the respective price points at which those products or services are offered. In another embodiment, the keyword comparison module 250 compares the content providers associated with the campaigns based on information contained in the content provider profiles stored in the content provider database 230.

In one embodiment, the keyword comparison module 250 adjusts the similarity scores based on the frequency of occurrence of the keywords. For example, assume that the keywords associated with a new content campaign are “trendy,” “affordable,” and “boots,” and that an existing campaign includes only the keyword “boots.” If the term “boots” appears multiple times in the existing campaign, the keyword comparison module 250 increases the campaign's similarity score despite the fact that the campaign does not use the other keywords associated with the new advertising campaign. Conversely, the similarity score is adjusted downward if the keyword comparison module 250 determines that the keywords appear infrequently in the existing campaign or are unrelated to the purpose of the campaign (e.g., a keyword appears in a fine print disclaimer at the bottom of the content).

In another embodiment, the keyword comparison module 250 employs a weighting scheme when adjusting the similarity scores such that certain terms are weighted more heavily than others. Keywords that the keyword comparison module 250 determines are more common across content items on the online system 140 are given less weight in computing the similarity score than keywords that appear less frequently. For example, assume that the keywords associated with a new content campaign are “apparel” and “cardigan.” If the keyword comparison module 250 determines that the term “apparel” appears frequently in many different types of sponsored content (e.g., men's athletic gear, baby clothes, women's suits, etc.), the keyword comparison module 250 affords less weight to that keyword than to “cardigan,” which appears less frequently. In still another embodiment, when a content provider inputs into the online system 140 the keywords associated with a new campaign, the content provider ranks the keywords, and the keyword comparison module 250 uses the ranks to adjust the similarity scores.

In some embodiments, a content provider may use a determination of similarity to make or adjust a bid amount. The bid amount is associated with sponsored content provided by a content provider and specifies an amount of compensation the content provider provides the online system 140 if the content is presented to a user or accessed by a user. In one embodiment, the bid amount is used by the online system 140 to determine an expected value, such as monetary compensation, received by the online system 140 for presenting the content to a user, if the content receives a user interaction, or based on any other suitable condition. For example, the bid amount specifies a monetary amount that the online system 140 receives from the content provider if the content is displayed and the expected value is determined based on the bid amount and a probability of a user accessing the displayed content.

In one embodiment, a content provider associated with a new campaign calculates an initial bid in an online content auction in response to the bids of content providers that the keyword comparison module 250 labels as similar to the content provider. In another embodiment, the content provider increases or otherwise adjusts a previously made bid in response to the keyword comparison module 250 labeling additional content providers as similar to the content provider.

Upon determining that a content campaign is similar to the new content campaign, the keyword comparison module 250 retrieves the target audience for the similar campaign stored in the content provider database 230. In one embodiment, the target audience for the similar campaign includes a definition of the characteristics of the audience, such as all males 18-20 in age whose profiles indicate an interest in basketball and athletic shoes, and who have visited a website selling athletic shoes in the last 20 days. This definition includes a collection of users of the online system 140 to whom the content provider has targeted or plans to target the content item associated with the similar content campaign.

The audience recommendation module 255 generates a target audience for the new content campaign based at least in part on the target audiences for the similar content campaigns. In one embodiment, the target audience includes specific users of the online system 140. In another embodiment, the targeting is generalized based on user characteristics as determined by the characteristics of a subset of users of the online system 140. Characteristics may include demographic information about users of the online system 140, such as age, gender, political views, education status, college year, relationship status, gender(s) interested in dating, and geographic region information. Thus, the target audience may be identified in advance as a list of users, or the audience may be identified as a statement of characteristics or targeting criteria for those users, and the system may determine at impression time, when an opportunity to provide an impression to a user presents itself, whether that user falls in the audience or not. In other words, the audience may be a list of identifiers in the online system of particular users who have been determined in advance to meet the targeting criteria, or the audience may simply be identified as the targeting criteria itself and the users falling within the targeting criteria may be identified at impression time.

The audience recommendation module 255 incorporates users of the online system 140 targeted by the similar content campaigns as well as previously untargeted users to generate the target audience for the new campaign. In some embodiments, the percentage of users targeted by other campaigns varies in proportion to the similarity scores calculated by the keyword comparison module 250.

Once the audience recommendation module 255 generates criteria defining a target audience for the new campaign or a list of users targeted by the similar content campaigns, the audience recommendation module 255 determines the best recommendation. In one embodiment, it provides the criteria defining the target audience to the content provider for the content provider to use for the content provider to use as its own audience. In another embodiment, the system uses “look-alike” targeting to determine other users of the online system 140 to add to the target audience for the new campaign. The audience recommendation module 255 identifies a second set of users of the online system 140 that are similar to the previously identified users based on past engagement history (e.g., click-through rates), demographic information, or direct or indirect connections with previously targeted users. Targeting users of an online system that are similar to a previously identified group of users is described further in U.S. application Ser. No. 13/297,117, filed on Nov. 15, 2011, which is hereby incorporated by reference in its entirety.

Alternatively, the audience recommendation module 255 generates a target audience for the new content campaign by determining an overlap between two target audiences whose keywords are similar to the keywords associated with the new campaign. The audience recommendation module 255 extracts the overlapping audience from the two target audiences and includes that group of users in the target audience for the new campaign. In one embodiment, the audience recommendation module 255 takes a weighted union such that both overlapping users and non-overlapping users are included in the new target audience, but overlapping users are included at a higher proportion.

One or more content requests are stored in the content request store 260. A content request includes sponsored content and a bid amount. The sponsored content is text data, image data, audio data, video data, and any other data suitable for presentation to a user. In various embodiments, the sponsored content also includes a network address specifying a landing page to which a user is directed when the content is accessed. As discussed above, in some embodiments, the content provider can set or adjust the bid amount responsive to the keyword comparison module 250 labeling additional content providers as similar to the content provider.

### Use Case

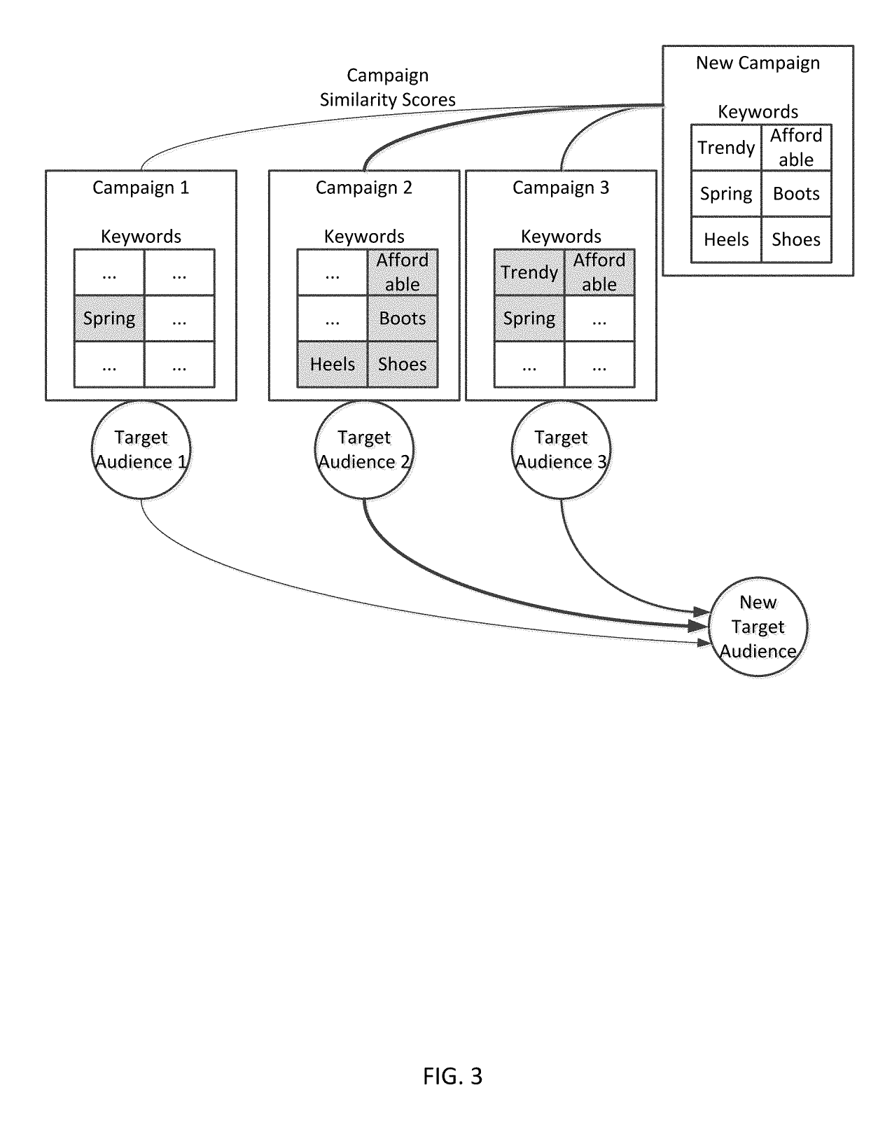

FIG. 3 shows a conceptual illustration of a method for creating target audiences using labeled content campaign characteristics, in accordance with an embodiment. The online system 140 receives a new content campaign associated with the keywords “Trendy,” “Affordable,” “Spring,” “Boots,” “Heels,” and “Shoes.” In one embodiment, the creator of the new campaign manually inputs the keywords into the online system 140. In another embodiment, the keyword extraction module 240 extracts the keywords from other content associated with the content provider, as described above in conjunction with FIG. 2.

The keyword comparison module 250 calculates similarity scores based on the matched keywords between the new campaign and each of Campaigns 1-3. For example, Campaign 1 initially has the lowest similarity score because the only matched term between Campaign 1 and the new campaign is “Spring.” However, in some embodiments, the keyword module 235 increases the similarity score of Campaign 1 if the term “Spring” appears frequently in Campaign 1, if “Spring” is not a frequently used keyword, or if the creator of the new campaign ranks “Spring” as an important keyword. One of ordinary skill in the art will recognize that many variations and modifications are possible in light of the disclosure.

Campaign 3 is initially assigned a higher similarity score than Campaign 1 because of the increased overlap in keywords between Campaign 1 and the new campaign. As with Campaign 1, in some embodiments, the keyword comparison module 250 adjusts the similarity score of Campaign 3 upward or downward based on frequency, popularity, ranking of keywords, or other factors. The keyword comparison module 250 assigns Campaign 2 the highest initial similarity score because four of the new campaign's six keywords match keywords associated with Campaign 2.

If the keyword comparison module 250 determines that each of Campaigns 1-3 is similar to the new campaign, the audience recommendation module 255 identifies the target audiences associated with the similar campaigns. In one embodiment, the target audience includes specific users of the online system 140. In another embodiment, the target audience may be generalized based on user characteristics as determined by a subset of users of the online system 140.

The audience recommendation module 255 incorporates users of the online system 140 that have previously been targeted by content campaigns on the online system 140 as well as users that have not been targeted. In one embodiment, the percentage of users targeted by previous content campaigns is adjusted in proportion to the calculated similarity scores.

Alternatively, the audience recommendation module 255 uses “look-alike” targeting to determine additional users of the online system 140 to add to the target audience based on similarities between those users and the subset of users that were previously targeted. In another embodiment, the audience recommendation module 255 generates a target audience based on overlap between two target audiences associated with content campaigns that are similar to the new content campaign. In some embodiments, the audience recommendation module 255 uses a weighted union such that both overlapping users and non-overlapping users are included in the new target audience, but overlapping users are included at a higher proportion.

### Exemplary Method

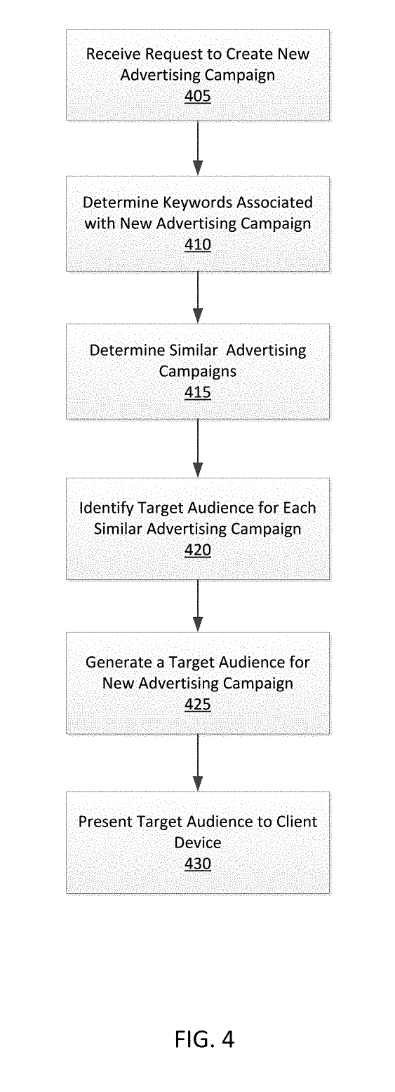

FIG. 4 is a flow chart illustrating an example method for using advertising labels to generate a target audience for a new content campaign, according to one embodiment. An online system 140 receives 405 a request to create a new content campaign on the online system 140. In one embodiment, the entity associated with the new campaign is a new content provider. In another embodiment, the entity associated with the new campaign is a current provider who is beginning a new content campaign.

The input module 235 and the keyword extraction module 240 determine 410 keywords associated with the new content campaign. In one embodiment, the content provider inputs the keywords through the input module 235. Alternatively, the keyword extraction module 240 retrieves the keywords from other content associated with the content provider, as described above in conjunction with FIG. 2.

The keyword comparison module 250 determines 415 content campaigns that are similar to the new content campaign. In one embodiment, the keyword comparison module 250 assesses similarity by calculating a similarity score based on matches between the keywords associated with the new campaign and the keywords associated with the existing campaigns. In one embodiment, the similarity score is determined by the number of keywords associated with the new content campaign that are also associated with the existing campaign. The keyword comparison module 250 may adjust the similarity score based on frequency of occurrence of the keywords. In another embodiment, the keyword comparison module 250 employs a weighting scheme to decrease the effect on the similarity score of keywords that are common across content on the online system 140 and increase the effect on the similarity score of keywords that appear less frequently. In another embodiment, the content provider ranks the keywords associated with a new content campaign, and the keyword comparison module 250 uses the ranking to adjust the similarity scores.

For each of the content campaigns that the keyword comparison module 250 deems similar to the new campaign, the audience recommendation module 255 identifies 420 the target audience associated with the similar campaign in order to generate a target audience for the new campaign. In one embodiment, the target audience for a similar campaign comprises a list of users of the online system 140 to whom the content provider targets a content item associated with the similar campaign. In one embodiment, the target audience is defined by characteristics of the users of the online system 140 that comprise the target audience. Additionally or alternatively, the audience recommendation module 255 defines the target audience based on past engagement with content items on the online system 140, direct or indirect connections with other users of the online system 140, or installation of an application associated with the content provider. In still another embodiment, the target audience is a list of individual users of the online system 140.

The audience recommendation module 255 generates 425 a target audience for the new content campaign based on at least a portion of the target audience of similar content campaigns, as described above. The audience recommendation module 255 then presents 430 the target audience for the new campaign to the client device.

### ADDITIONAL CONSIDERATIONS

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may be comprise a general-purpose computing device selectively activated or reconfigured by a computer program stored on a computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Finally, the language used in the specification has been principally selected for readability and instructional purposes; it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the embodiments, which is set forth in the following claims.

1. A method comprising:
receiving, by an online system from a client device, a request to generate a new content campaign for a content provider on the online system;
determining, by the online system, keywords associated with the new content campaign by:
receiving at least one keyword from the content provider about the campaign, and
extracting at least one keyword from information provided to the online system by the content provider;
comparing the determined keywords for the new content campaign with keywords stored for other content campaigns that were previously determined by the online system for the other content campaigns;
identifying one or more of the other content campaigns as matching content campaigns based on a threshold level of match between stored keywords for the other campaigns and the determined keywords for the new content campaign;
identifying, for each of the matching content campaigns, a target audience of users of the online system to whom the matching content campaign targets content items;
generating a target audience for the new content campaign based at least in part on the target audiences of the identified matching content campaigns; and
presenting the target audience for the new content campaign to the client device as a recommendation by the online system for the new content campaign.

2. The method of claim 1, wherein extracting at least one keyword comprises extracting the keyword by the online system from sponsored content associated with the new content campaign.

3. The method of claim 1, wherein extracting at least one keyword comprises extracting the keyword by the online system from an online system profile about the content provider.

4. The method of claim 1, wherein extracting at least one keyword comprises extracting the keyword by the online system from a brand page within the online system that is associated with the content provider's profile.

5. The method of claim 1, wherein extracting at least one keyword comprises extracting the keyword by the online system from a third-party website that is separate from the online system and that is affiliated with the content provider.

6. The method of claim 1, further comprising ranking the keywords based on the number of times that each of the keywords appears in the information.

7. The method of claim 1, further comprising ranking the keywords based on the placement of each of the keywords in the information.

8. The method of claim 1, further comprising ranking the keywords based on how conspicuous the keywords are relative to surrounding text.

9. The method of claim 1, wherein identifying one or more of the content campaigns as matching content campaigns comprises calculating a similarity score above a threshold level of match.

10. The method of claim 9, further comprising adjusting the similarity score based on the frequency of occurrence of the keywords.

11. The method of claim 9, further comprising adjusting the similarity score based on the popularity of the keywords.

12. The method of claim 9, further comprising adjusting the similarity score based on a ranking of keywords provided by the content provider or performed by the online system.

13. The method of claim 1, wherein generating a target audience for the new content campaign further comprises extracting an overlapping subset of users targeted by two or more content campaigns.

14. The method of claim 13, further comprising including the overlapping subset of users at a higher proportion than non-overlapping users.

15. The method of claim 1, further comprising calculating a bid amount or adjusting a bid amount associated with the content campaign in response to the online system labeling another content provider as similar to the content provider associated with the content campaign.

16. A non-transitory computer readable storage medium storing instructions that, when executed by a computing system, cause the computing system to perform operations comprising:
receiving, by an online system from a client device, a request to generate a new content campaign for a content provider on the online system;
determining, by the online system, keywords associated with the new content campaign by:
receiving at least one keyword from the content provider about the campaign, and
extracting at least one keyword from information provided to the online system by the content provider;
comparing the determined keywords for the new content campaign with keywords stored for other content campaigns that were previously determined by the online system for the other content campaigns;
identifying one or more of the other content campaigns as matching content campaigns based on a threshold level of match between stored keywords for the other campaigns and the determined keywords for the new content campaign;
identifying, for each of the matching content campaigns, a target audience of users of the online system to whom the matching content campaign targets content items;
generating a target audience for the new content campaign based at least in part on the target audiences of the identified matching content campaigns; and
presenting the target audience for the new content campaign to the client device as a recommendation by the online system for the new content campaign.

17. The non-transitory computer readable storage medium of claim 16, wherein extracting at least one keyword comprises extracting the keyword by the online system from sponsored content associated with the new content campaign.

18. The non-transitory computer readable storage medium of claim 16, wherein extracting at least one keyword comprises extracting the keyword by the online system from an online system profile about the content provider.

19. The non-transitory computer readable storage medium of claim 16, wherein identifying one or more of the content campaigns as matching content campaigns comprises calculating a similarity score above a threshold of match.

20. The non-transitory computer readable storage medium of claim 16, wherein generating a target audience for the new content campaign further comprises extracting an overlapping subset of users targeted by two or more content campaigns.
